(19) United States
(12) Patent Application Publication
(10) Pub. No.: US 2013/0239538 A1
(43) Pub. Date: Sep. 19, 2013

(54) Shearing power mower blade

(71) Applicant: David O. Gohsman, Saint Stephens Church, VA (US)

(72) Inventor: David O. Gohsman, Saint Stephens Church, VA (US)

(21) Appl. No.: 13/385,948

(22) Filed: Mar. 16, 2012

(51) Int. Cl. A01D 34/52

(52) U.S. Cl. 56/255

(57) ABSTRACT

This mower blade design is intended to cut vegetation (turf, grass or other similar growth) by employing an extreme low or indirect angle of blade attack instead of a direct, head-on, 90 degree impact angle of attack used by most conventionally blades available today. Design is especially effective where the mower is to be operated in sandy or rocky soil. The design increases the life of the blade from one year season to four or five years. Design allows the blade to remain sharp since its cutting edge is out of the direct path of sand, rocks and other debris. Cutting on a low, indirect angle provides shearing or slicing action producing an improved cut similar to that of “reel” mowers. This blade is designed to be used in all conventional rotary mowers.

### CROSS REFERENCE TO RELATED APPLICATIONS

### Statement

### FEDERAL SPONSORSHIP

### Statement

### JOINT RESEARCH AGREEMENT

### Statement

### BACKGROUND OF THE INVENTION

### Statement

### FIELD OF INVENTION

### Statement

### SUMMARY OF INVENTION

### Statement

The blade is produced of 3/16 inch thick steel; as designed its cutting edge is located in an area where there is little abrasion caused by items such as sand and small stones. A lift tab is placed on the trailing edge of the outer side of the blade to lift grass and increase pressure to eject the cut particles. The blade is a balanced “S” shaped rather than a flat bar conventionally employed by most current blade design. The sharpened edge encounters the grass or material to be cut at an angle close to parallel whereas; on a conventional blade the cutting edge is 90 degrees to the angle of cut. As the shearing blade turns, the lift tab directs debris out of the mower just ahead of the cutting edge, limiting the sand and small stones, and sending them out of the clippings port of the mower.

Conventional blades become dull in the first few uses of the blade and continue thereafter until the blade is sharpened or replaced. However, most blade users choose to not sharpen the blades instead replacing them more frequently. This design allows the user to save money on both purchase of new blades and sharpening of old blades.

### DRAWING INFORMATION DESCRIPTIONS

### Several Views

### Introduction

The Drawing Information Description provides detailed review of the drawings and their individual characteristics. The attached two drawings provide three views of the Shearing Mower Blade. This set of descriptions will allow persons reading the specification to understand the design and described function of the Shearing Mower Blade.

The drawings do not indicate any size of blade since the concept can be build to suit any existing or new rotary mower.

The aperture at the center of blade can be produced to suit any existing mower drive spindle or new mower designed spindle shaft shapes.

Current rotary mowers have one or more mower enclosed areas in which a mower blade is mounted on a drive spindle, at the center of mower rotation, located at the attachment to the mower drive (spindle). Both drawings use this as a basic orientation around which the blade rotates.

Drawing 1

A. Basic Information and Orientation:

This drawing shows the “S” shape of the Shearing Mower Blade and all of its features. As shown, the blade is installed on a rotary mower to rotate clockwise, as seen in the center of the drawing, on the axis of the attachment to the spindle.

As the blade rotates, it presents the sharpened area to the grass in a shearing manner without direct impact to the material being cut.

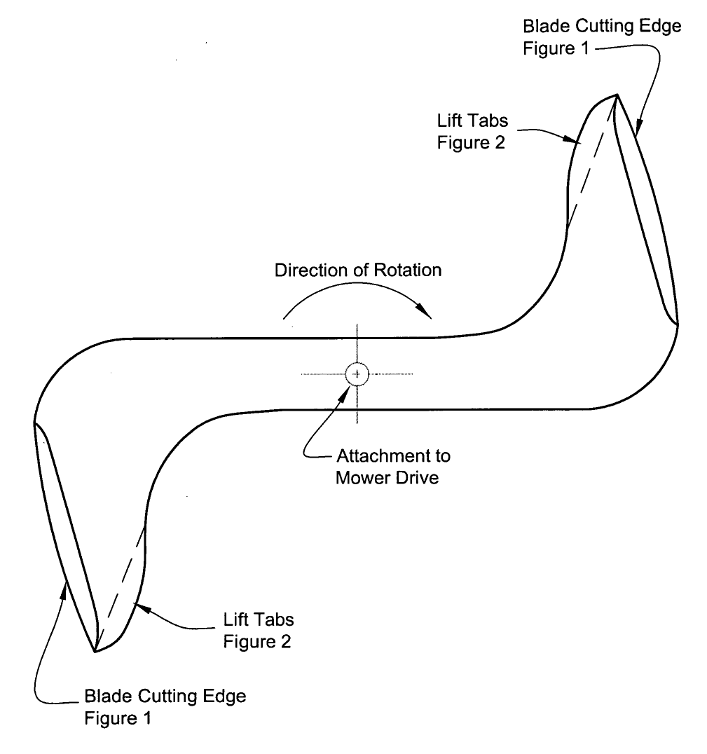

A. The Cutting Edge: (FIG. 1)

The shearing blade is comprised of a flat piece of steel with two “L” shaped ends connected by a flat bar. Each end is elongated into the “L” shape to carry the cutting edge shown as FIG. 1. This cutting edge is angled back from a line parallel with the line of cut. The cutting edge of the Shearing Mower Blade travels in a circle which is greater than the area of the cutting. When the blade is turned it cuts in a shearing manner shearing the grass or other plant material as the mower pulls the spinning blade forward. Material is sheared off just as a blade is drawn against the plant stems rather than a direct blunt stroke.

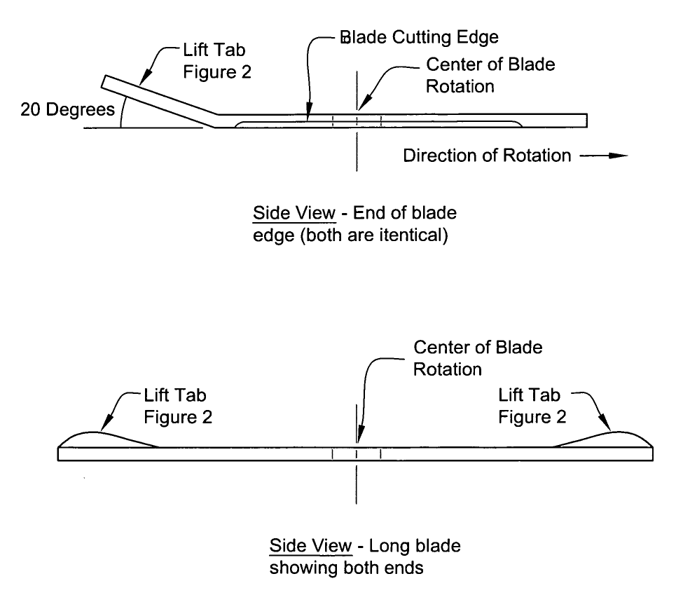

B. The Lift Tab: (FIG. 2)

A lift tab is located at the trailing edge of each blade, near the cutting surface (FIG. 2). This Lift tab develops lift and vacuum force which ejects the grass clippings and other material out of mower.

Since the debris within the mower also travels in a circle bounded by the mower enclosure, the debris makes minimal contact with the actual cutting surface. The placement of the cutting edge (FIG. 1) allows the blade to cut the grass and avoid the dulling debris that is picked up along with the grass and allows the blade to retain a sharp cutting edge.

Drawing 2

Basic Information and Orientation:

Drawing 2 provides two views of the blade: a side view and a long view showing both ends.

A. First View: Side

This view shows the Shearing Blade from the end of the blade which carries the cutting edge. Attached to the cutting edge area is the lift tab show as FIG. 2 of drawing 2.

The blade rotates clockwise pulling the lift tab which creates a partial vacuum and lifts the grass as well as eject the grass clippings and accumulated debris out of the mower.

FIG. 2 shows the Lift tab to be set at an average 20 degrees. This may be more or less than is used on other blades employing this technique. A greater angle will produce more lift or vacuum and will use more energy produced by the mower to rotate the mower blade.

B. Second View: Long

This view shows the full Shearing Mower Blade from the long view. Each of the lift tabs and the cutting edges are identical in shape and create balance when in rotation. Each Lift tab is show at opposite ends of the blade equidistant from the center of the blade.

Summary: Drawing 1 and 2 show the blade from three views which describe the blade as a three, dimensional device. The single blade is comprised of two cutting ends with sharpened edges, and two Lift tabs. These features are spaced equidistant from the center of blade rotation at the attachment to the mower (spindle) drive. Length and cutting edge as well as Lift tab placement is intended to be designed for each unique mower application. The concept of the Shearing Mower Blade may be applied to various rotary mowers or devices that use such a blade.

1. The design results in a much longer life of the blade; approximately four to five times longer than conventional blades. Less blade speed is needed to produce the same cutting/mowing result. Lower blade speed translates into less fuel used by mowers for the same cutting result.

2. The blade cutting edge remains sharp longer. Non-impact area positioning of the cutting edge reduces rock and sand damage. Cost reduction to produce, maintain and operate mowers is a secondary result of this blade design. The design also allows the blade to be produced of thinner metal, thus requiring less energy by the mower to turn the blade. The reason the blade stays sharp longer is that the blade is running nearly parallel with rock, pebble and sand which is caught up in the blade whirlwind which propels the cutting debris out of the mower.

3. Grass and turf recovery time is reduced and less plant damage is experienced. With a sharper longer lasting blade the grass is cleanly cut and not pulled apart by impact allowing the grass to experience less trauma. A cleaner cut result on the shear instead of a dull blade bursting the plant.
